(19) United States
(12) Patent Application Publication
(10) Pub. No.: US 2013/0245201 A1
(43) Pub. Date: Sep. 19, 2013

(54) LLDPE-LDPE BLOWN FILM BLEND

(71) Applicants: KHALED MEZGHANI, DHAHRAN (SA); SARFARAZ AHMED FURQUAN, HYDERABAD (IN)

(72) Inventors: KHALED MEZGHANI, DHAHRAN (SA); SARFARAZ AHMED FURQUAN, HYDERABAD (IN)

(73) Assignees: KING ABDULAZIZ CITY FOR SCIENCE AND TECHNOLOGY, RIYADH (SA); KING FAHD UNIVERSITY OF PETROLEUM AND MINERALS, DHAHRAN (SA)

(21) Appl. No.: 13/423,082

(22) Filed: Mar. 16, 2012

(51) Int. Cl. C08L 23/08

(52) U.S. Cl. 525/240

(57) ABSTRACT

The LLDPE-LDPE blown film blend is a blown film made from a mixture of unimodal hexene-LLDPE (also referred to as h-LLDPE) and LDPE having a blend ratio between 2%-10% of LDPE added to 98%-90% of h-LLDPE. This blend results in a TD (transverse direction) tear resistance increase by 100% for a composition of between 2%-10% of LDPE with LLDPE. Impact failure energy increases by 20% for the composition of 5% LDPE with 95% h-LLDPE. There is improvement in strength in the TD direction for the composition starting at 10% of LDPE with h-LLDPE. The toughness in the MD (machine direction) direction increases for the compositions of approximately 10% LDPE with h-LLDPE. Moreover, film production of a composition starting at approximately 10% of LDPE with LLDPE requires less energy.

### BACKGROUND OF THE INVENTION

1. Field of the Invention

The present invention relates to blown film polymer compounds, and particularly to a LLDPE-LDPE blown film blend.

2. Description of the Related Art

Polyethylene (PE) is the most commercially used polymer in the form of films. PE is primarily chosen from the set of polymers due to its low price and easy processability. PE comes in different grades according to its density and molecular structure (branching). It has been classified into three main categories, namely, high density (HDPE), low density (LDPE), and linear low density (LLDPE). HDPE has a density in the range of 935-965 kg/m³. It is densely packed with a low degree of branching, which results in stronger intermolecular forces and tensile strength. LDPE is characterized by a density in the range of 918-935 kg/m³. The molecules in it are less tightly packed than HDPE and have a high degree of short- and long-chain branching, thereby exhibiting less crystalline structure. LLDPE has a density in the range of 915-925 kg/m³ with a significant number of short branches, but without long chain branching. LLDPE is commonly produced via a copolymerization process, usually referred to as butene-, hexene- and octene-LLDPE, depending on the co-monomer used.

Within the family of PE resins, low-density polyethylene (LDPE) and linear low-density polyethylene (LLDPE) resins have found extensive application in the packaging area using film blowing process. The mechanical properties of the PE films depend significantly on such variables as the extent and type of branching, the crystal structure, and the molecular weight. When comparing LDPE and LLDPE, it has been observed that the LDPE offers very good processability with lower mechanical properties. On the other hand, LLDPE exhibits better mechanical properties with lower processability. These PE films play an important role in the packaging industry, and the demand for a vast range of mechanical properties is met by blending different types of resins.

These films are produced by a film blowing process. This process is the same as a regular extrusion process up until the die. The extrusion process can be attained by a single screw or a double screw extruder. The die is an upright cylinder with a circular opening similar to that of a pipe die. The pellets are fed into the extruder barrel through a metered feeder at a constant mass flow rate. The extruder screws are driven by a motor, and its speed can be changed as desired. The pellets melt in the extruder and then the melt is pushed out through an adaptor die located at the exit of the extruder. The melt then flows through a melt pump, which supplies the molten plastic to the die at a constant mass flow rate. This melt then flows through the die channel and squeezes out through the die opening. The molten plastic is then pulled upwards from the die by a pair of nip rolls high above the die. In the center of the die there is an air inlet from which compressed air can be forced into the center of the extruded circular profile, creating a bubble. This expands the extruded circular cross section by some ratio (a multiple of the die diameter), thus decreasing the wall thickness. This ratio is called the “blow-up ratio.” There is also an external air cooling ring attached to the die, which cools the bubble from the outer surface. The nip rolls flatten the bubble into a double layer film. This film is then spooled on a drum.

The product qualities of these films are immensely dependent on its morphological and mechanical properties. The structure and mechanical properties are, in turn, dependent on the processing variables and the molecular characteristics of the resin. Although different film markets have different performance requirements, superior tear, tensile, and dart impact strength are always desired. It has been recognized that film performance is strongly dependent upon the orientation of both the crystalline phase and amorphous chains, which, in turn, are largely influenced by the fabrication process and polymer chain microstructure. The morphology and property differences among high density PE (HDPE), low density PE (LDPE), and linear low-density PE (LLDPE) films have also been demonstrated and explained in the prior art, but the combined effect of these polymers is still in the initial stages. It is apparent that blended LLDPE-LDPE may have desirable film processability and mechanical properties that neither polyethylene formulation possesses alone.

Thus, an LLDPE-LDPE blown film blend solving the aforementioned problems is desired.

### SUMMARY OF THE INVENTION

The LLDPE-LDPE blown film blend is a blown film made from a mixture of unimodal hexene-LLDPE (also referred to as h-LLDPE) and LDPE having a blend ratio between 2%-10% of LDPE added to 98%-90% of h-LLDPE. This blend results in a TD (transverse direction) tear resistance increased by 100% for a composition of between 2%-10% of LDPE with LLDPE. Impact failure energy increases by 20% for the composition of 5% LDPE with 95% h-LLDPE. There is improvement in strength in the TD direction for the composition starting at 10% of LDPE with h-LLDPE. The toughness in the MD (machine direction) direction increases for the compositions of approximately 10% LDPE with h-LLDPE. The yield strength in the MD direction increases for the composition between 10%-20% of LDPE with h-LLDPE. Moreover, film production of a composition starting at approximately 10% of LDPE with LLDPE requires less energy.

These and other features of the present invention will become readily apparent upon further review of the following specification and drawings.

### BRIEF DESCRIPTION OF THE DRAWINGS

FIG. 1 is a plot showing TD (transverse direction) tear resistance for a preferred embodiment of an LLDPE-LDPE blown film blend according to the present invention.

FIG. 2 is a plot showing Total Failure Energy for a preferred embodiment of an LLDPE-LDPE blown film blend according to the present invention.

FIG. 3 is a plot showing TD tensile stress-strain for a preferred embodiment of an LLDPE-LDPE blown film blend according to the present invention.

FIG. 4 is a plot showing MD (machine direction) toughness for a preferred embodiment of an LLDPE-LDPE blown film blend according to the present invention.

FIG. 5 is a plot showing MD yield stress for a preferred embodiment of an LLDPE-LDPE blown film blend according to the present invention.

Similar reference characters denote corresponding features consistently throughout the attached drawings.

### DETAILED DESCRIPTION OF THE PREFERRED EMBODIMENTS

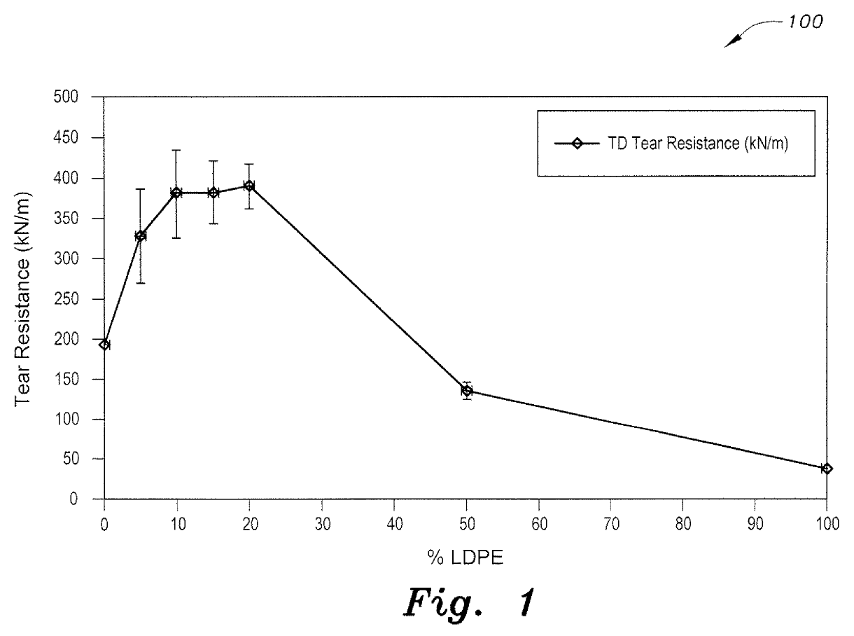

The LLDPE-LDPE blown film blend is blown film made from a mixture or blend of unimodal h-LLDPE and LDPE having a blend ratio between 2%-10% of LDPE added to 98%-90% of h-LLDPE. As shown in the experimental results plot 100 of FIG. 1, this blend results in a TD (transverse direction) tear resistance increase of approximately 100% for a composition of h-LLDPE and LDPE having between 2%-10% of LDPE added to between 98%-90% h-LLDPE. The tear resistance increases at a constant linear rate between 2% LDPE and approximately 10% LDPE blend percentages.

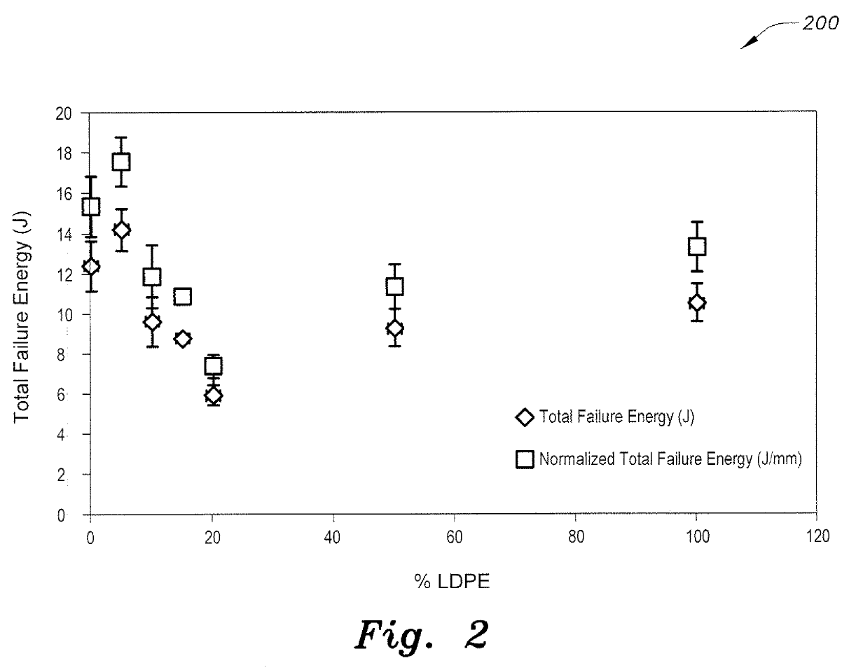

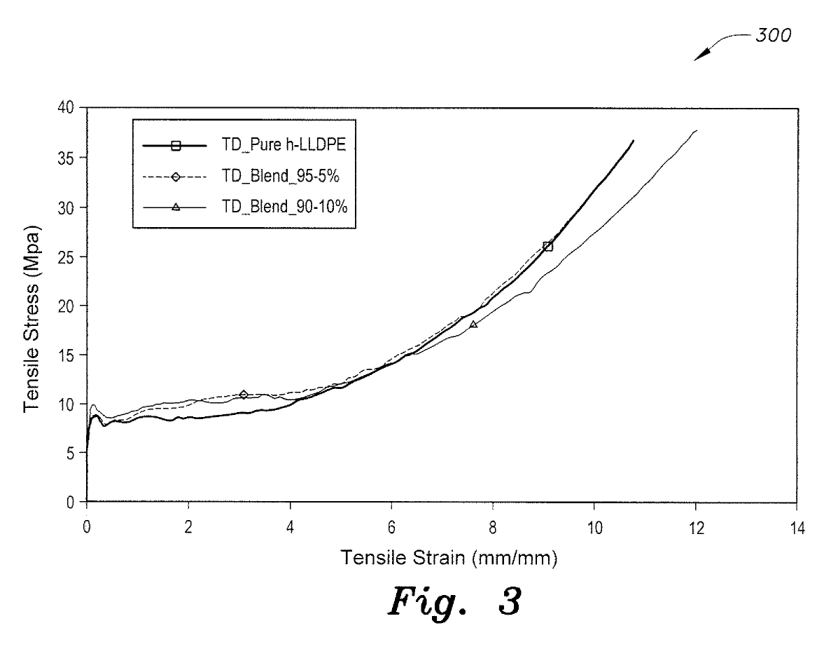

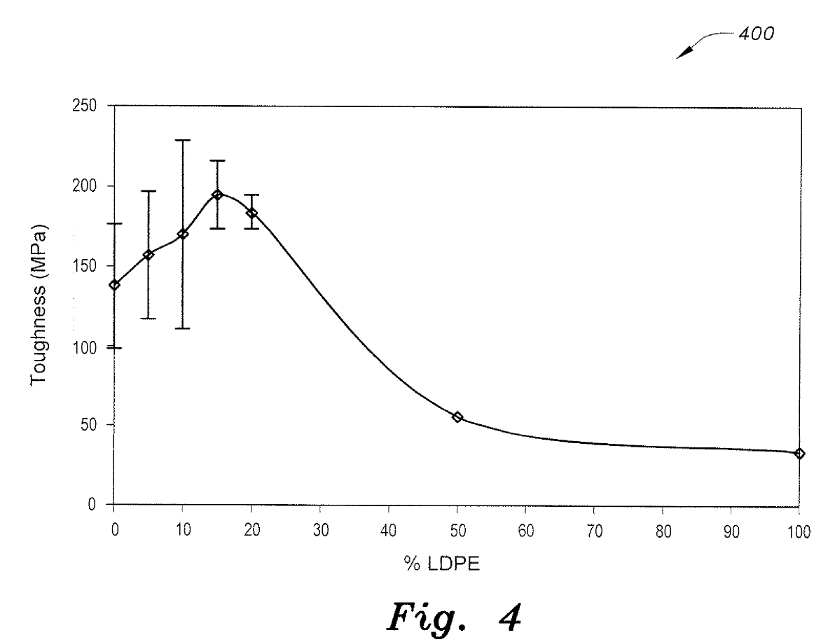

As shown in the experimental results plot 200 of FIG. 2, impact failure energy may also increase by 20% for the LLDPE-LDPE composition having 5% LDPE with 95% h-LLDPE. The failure energy peaks for an LDPE blend between 2% LDPE and approximately 6%. As shown in the experimental results plot 300 of FIG. 3, there may be an improvement in strength in the TD direction for the LLDPE-LDPE composition starting at 10% of LDPE added to 90% h-LLDPE. As shown in the experimental results plot 400 of FIG. 4, the toughness in the MD (machine direction) direction may increase by 43% for an LLDPE-LDPE composition having approximately 10% LDPE and approximately 90% h-LLDPE. The MD toughness peaks at a constant linear rate between 2% LDPE and approximately 6% LDPE blend percentages.

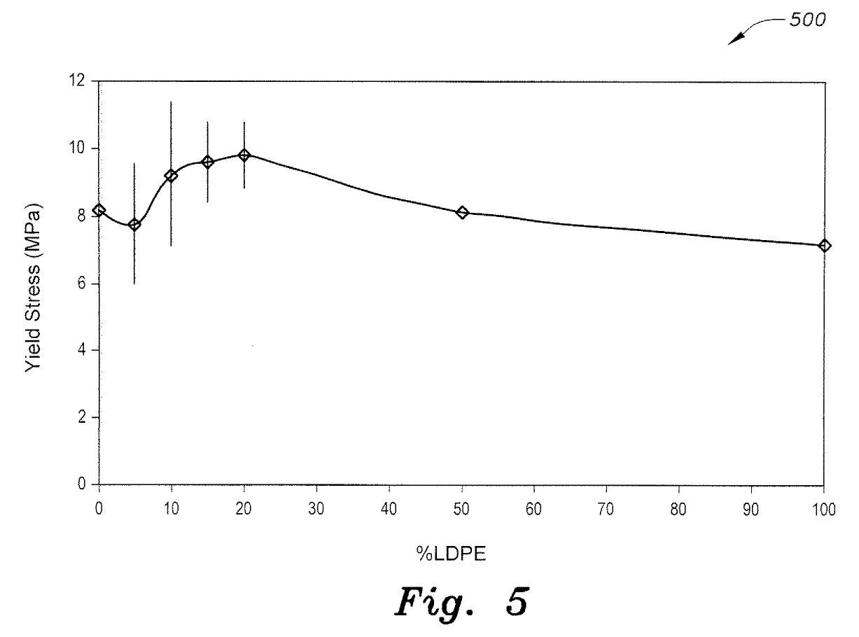

As shown in the experimental results plot 500 of FIG. 5, the yield strength in the MD direction may increase for the LLDPE-LDPE composition starting at approximately 10% LDPE added to approximately 90% h-LLDPE. Moreover, film production of an LLDPE-LDPE composition starting at approximately 10% of LDPE added to approximately 90% h-LLDPE may require less energy to produce than the pure unblended polymer film production.

The h-LLDPE in the LDPE-LLDPE blends is produced using a Ziegler-Natta catalyst, not by a metallocene catalyst. The h-LLDPE used in forming the blends were furnished as pellets of the resin furnished by SABIC, and in particular, Sabic 6821N, which is a high performance hexene copolymer having a melt index of 0.8 g/10 min. and a density of 0.921 g/cm³. The LDPE was also furnished by SABIC in pellet form, specifically, Sabic HP2022 having a melt flow rate of 2 g/10 min. at 190° C. and 2.16 kg load, and a density at 23° C. of 922 kg/m³. The experimental blends of LDPE with h-LLDPE were produced with the help of a Thermo Haake twin-screw extruder. This extruder was designed with an L/D ratio of 40. All the heating zones and the screw speeds were externally controlled with a computer. The temperatures of the melt were measured using thermocouple sensors, and the pressure at the extruder exit was measured with a pressure sensor. The torque required to turn the screw was being electronically reported on the computer. The pellets are fed into the extruder barrel through a metered feeder at a constant mass flow rate. The extruder screws are driven by a motor, and its speed can be changed as desired. The pellets melt in the extruder, and then the melt is pushed out through an adaptor die located at the exit of the extruder. The melt then flows through a melt pump, which supplies the molten plastic to the die at a constant mass flow rate. The melt then flows through the die channel and squeezes out through the die opening. The molten plastic is then pulled upwards from the die by a pair of nip rolls high above the die, a known procedure. In the center of the die, there is an air inlet from which compressed air can be forced into the center of the extruded circular profile, creating a bubble. This expands the extruded circular cross section by some ratio (a multiple of the die diameter), thus decreasing the wall thickness. This ratio is called the “blow-up ratio.” There is also an external air cooling ring attached to the die, which cools the bubble from the outer surface. The nip rolls flatten the bubble into a double layer film. This film is then spooled on a drum. The twin screw extruder had seven controllable heating zones up to the extruder exit. A temperature profile of 120/150/180/200/200/200/200° C. was maintained in the extruder. It had three mixing zones with mixing elements. The material feeding was achieved with the help of a controlled feeder. This feeder was also being controlled by the same computer.

By increasing the temperature profile values the processability increases but this would lead to polymer degradation at higher temperatures. At the same time, for low extrusion temperature profile values, the torque required to turn the screw was too high. The melting temperature of h-LLDPE is around 120° C. For very low extrusion temperature profiles, the torque required to turn the screw increases, and the motor gets tripped off with the equipment shutting down.

Thus, the above temperature profile was selected by taking into account the processability, polymer degradation and the equipment limitations concerns. Keeping this temperature profile as constant, the other parameters were optimized to obtain a maximum mass flow rate. This was achieved by varying the processing parameters, such as the screw speed and the melt pump speed. The extruder speed was varied from 0-12 rpm, and it was found that the torque required to turn the screw was maximum at the speed of 12 rpm with h-LLDPE material at a constant pressure of 14 to 16 bar at the extruder die exit. The melt pump was varied from 0 to 30 rpm feeding rate and was found to give a consistent flow rate at 10 rpm with 230° C. temperatures. Thus the melt pump speed was set to a constant feeding rate of 10 rpm at 230° C. to pump the material to the film blowing die.

The maximum mass flow rate at these feed rates was around 8 g/min. An extruder screw speed of 12 rpm was used and a constant pressure of 14 to 16 bar was maintained at the extruder die exit. For blending, a separate feeder was used. The pellets were simultaneously fed into the extruder barrel from the same point of entry. This kind of blending using two different feeders will give a better control on the homogeneity of the blend when compared to manual mixing of the material and feeding through a single feeder. The first feeder was used to feed the h-LLDPE pellets and the second feeder for LDPE pellets. The feed rates were controlled and calibrated so as to obtain the blend ratios of 5%, 10%, 15%, 20% and 50% of LDPE to the main material h-LLDPE.

After passing through the extruder, the polymer then flows into the melt pump, which is again being controlled by the same computer. The melt pump was set to a constant feeding rate of 10 rpm at 210° C. to pump the material to the film blowing die. A cylindrical film blowing die was used to blow the molten polymer. The die temperature with a diameter of 25 mm was set to 230° C. This die had an inlet from the bottom for the compressed air line to inflate or deflate the bubble so as to produce films of different width. The bubble diameter was varied to obtain different blow ratios (BRs). A compressed air line was connected to the bottom of the die, and the pressure inside the bubble was recorded using a pressure sensor. A cooling air ring was also placed on the top of the die to cool the film from outside. The material flowing out from this film blowing die was pulled up by the nip rolls of the take off unit. The speed of the nip rolls was varied, and the draw ratio (DR) was calculated using this speed of the nip roll over the speed of the film. The melt flow rate at the die exit was calculated by using the mass flow rate of the melt over the product of melt density at that temperature and the area of cross-section at the die opening. The equations for the speed of the film and the area are given by:

$$\begin{matrix}\begin{matrix}MeltVelocity m ( m \text{/} min ) = \frac{MassVelocity ( g \text{/} min )}{Density ( g \text{/} {cm}^{3} ) \times Area ( {cm}^{2} )} \times ( {10}^{- 2} m \text{/} cm ) \\ = \frac{m ( g \text{/} min )}{ρ ( g \text{/} {cm}^{3} ) A ( {cm}^{3} )} \times ( {10}^{- 2} m \text{/} cm )\end{matrix} & ( 1 ) \\ A = \frac{Π}{4} ( {D}_{o}^{2} - {D}_{i}^{2} ) & ( 2 )\end{matrix}$$

where Dₒ (2.50 cm) and Dᵢ (2.30 cm) are the outer and inner diameters of the die.

$$DR = \frac{FilmVelocity}{MeltVelocity} \qquad ( 3 )$$

Speed of the film=Speed of the nip rolls;

$$\begin{matrix}BR = \frac{Bubble Diameter}{Average Die Diameter} & ( 4 ) \\ m = Melt Mass Flow Rate ( g \text{/} min ) & ( 5 ) \\ {ρ}_{LLDPE} = 0.8674 - 6.313 \times {10}^{- 4} \times T + 0.367 \times {10}^{- 6} \times {T}^{2} - 0.055 \times {10}^{- 8} \times {T}^{3} & ( 6 ) \\ {ρ}_{LLDPE} = Melt Density ( g \text{/} {cm}^{3} ) = 0.7349 ( g \text{/} {cm}^{3} ) & ( 7 ) \\ {ρ}_{LDPE} = 0.868 exp ( - 6.73 \times {10}^{- 4} \times T ) & ( 8 ) \\ {ρ}_{LDPE} = Melt Density ( g \text{/} {cm}^{3} ) = 0.7345 ( g \text{/} {cm}^{3} ) & ( 9 ) \\ A = area ( {cm}^{2} ) = 0.7536 {cm}^{2} & ( 10 )\end{matrix}$$

Differential Scanning calorimetry thermograms were used to measure the percent crystallinity. Mettler DSC 882 was used in the present study for thermal analysis. Temperature calibration of the instrument was done with an indium sample. Samples were prepared by cutting circular discs from the film to fit into the aluminum pans. These discs were stacked until the weight was in the range of 3 mg to 5 mg. The crucibles were then covered with an aluminum lid and sealed. An empty sealed aluminum pan was used as a reference. Samples were scanned on Mettler DSC 882 unit from 20° C. to 180° C. for all the prepared samples at a rate of 10° C./min. The enthalpy value used for h-LLDPE was 293.6 J/g. Three samples at each condition were tested, and its average value has been reported.

An optical microscope along with a compensator was used to measure the degree of orientation in the films in both the machine direction (MD) and the transverse direction (TD). The microscope was set in dark field transmission mode with the lens axis appearing on the screen. A glass plate was kept between the polarizer and the analyzer with a compensator placed between the sample and the analyzer. The first dial reading of the compensator at this position was recorded. A rectangular sample of 8 cm×2.5 cm was prepared and placed between two glass plates. This assembly was then placed between the polarizer and the analyzer. The base was turned to an angle of + or − so as to observe the orientation in the MD direction of the film. The multi-cross was aligned with the axis of the lens and the compensator reading recorded. The orientation was measured as the retardation wavelength with respect to the dial increment of the compensator. The thickness of the film was also an important factor in deriving the degree of orientation in the film. The difference in retardation wavelength with the film and without the film was then divided upon its thickness to obtain the birefringence in the plane.

An Instron tensile testing machine was used for testing films in tension. The films were tested in accordance to the ASTM D 882 standard in both MD and TD directions. Specimens of rectangular type were cut using a die in both MD and TD with a gauge length of 15 mm and width 3.14 mm. The thickness was measured for different films using a high precision micrometer with an accuracy of 0.001 mm and then clamped between the jaws with a cardboard padding. The films were stretched at a controlled rate of 50 mm/min. A plot of tensile stress against tensile strain was obtained. The tensile properties, such as the yield stress, ultimate tensile strength, stress at break, and the toughness were determined from the graph. The toughness was calculated as the area under the curve of the stress strain graph. Five samples at each condition have been tested, and its average value has been reported.

Impact testing can be carried out using one of these standards, i.e., ASTM D 1709, ISO 7765-1, ISO 7765-2, or ASTM D3763. The test procedures mentioned in ASTM D 1709 and ISO 7765-1 are technically equivalent, and according to this test, the energy that causes plastic film to fail under specified conditions of impact of a free falling dart is evaluated. A freely falling dart impact tester was developed at our lab using the specifications as mentioned in the ASTM D1709. In this test, the energy is expressed in terms of the weight (mass) of the dart (missile) falling from a specified height resulting in 50% failure of the specimens that are being tested. This failure is the puncture of the film due to impact. Impact strength results by one test method vary from the other due to varying conditions of missile velocity, impinging surface diameter, effective specimen diameter, and the thickness. These test variables are highly dependent on the method of film fabrication.

The ASTM D 1709 or ISO 7765-1 standard consists of two test methods. Test method A employs a dart with a 38.10 mm diameter hemispherical head dropped from a height of 0.66 m. The test method A may be used for films whose impact resistances require masses of 0.05 Kg to about 2 kg to fracture them. Test method B employs a dart with a 50.80 mm diameter hemispherical head dropped from a height of 1.50 m. Its range of applicability is from 0.3 kg to about 2 kg.

One drawback of the ASTM D 1709 or ISO 7765-1 standard is the requirement of wide films because of the large film holder diameter. The ring clamp of the dart impact tester has an inner diameter of 127 mm, and the same is the case with ASTM D 3763, and wherein a fixture of clamping diameter of 76 mm is to be used. However, for the films processed, it was not large enough to be clamped within the 127 mm and 76 mm ring clamp. This would limit our study to the impact testing of films processed at medium and high BRs only. Hence, the most appropriate standard for testing all the specimens processed at different BR can only be achieved using the ISO 7765-2 standard. Thus, an instrumented dart impact tester (Instron 9250G) was used and the films were tested using the ISO 7765-2 standard. The Instron Dynatup 9250G is connected to a computer with impulse data acquisition and analysis system. The equipment comprises a gravity-based drop weight system with pneumatic brakes. A fixture of 40 mm inner diameter ring clamp was designed and manufactured in our lab. The fixture was manufactured as per the specifications mentioned in the ISO 7765-2 standard. The fixture was designed in such a way that the circular specimen was clamped flat and held securely during the test. A ring of emery paper was placed on the clamping faces to avoid any slippage. A dart of 0.78 inch in diameter was used for impact testing.

Samples of 80 mm diameter were cut in circular disc form and were piled over one another to make up a thickness of around 0.8 mm. A dart with 0.78 inch diameter was used for the impact test. The dart along with the tup weighed around 9.4 kg. The velocity of the dart striking the film clamped perpendicular to it was maintained at a constant value of 2 m/s. A method file designed for testing films as per ISO 7765 standard was used for the impact tests. Five samples with same processing conditions were tested, and its average impact resistance value was taken.

The principle for the instrumented dart impact test is that the test specimen is penetrated normal to its plane by a striker at a nominally uniform velocity. The resulting force deformation or force-time diagram is electronically recorded. The test specimen is firmly clamped during the test. The force deformation diagram obtained in these tests show several features of the material's behavior under impact. For example, the fracture may be “brittle”, “ductile”, “tough”, or characterized by initial damage or by crack initiation and propagation. In addition, dynamic effects may be present, such as load-cell/indentor resonance, specimen resonance and initial contact/inertia peaks. These resonance effects observed during the tests have been eliminated by the use of an algorithm to smooth the curve.

Various terms used in impact testing are peak force ‘F_{M}’, energy to peak force ‘W_{M}’, peak deformation ‘S_{M}’, failure force ‘F_{F}’, failure deformation ‘S_{F}’, failure energy ‘W_{F}’ and total penetration energy ‘W_{T}’. Peak force ‘F_{M}’, is the maximum force exerted by the striker in the direction of impact. Energy to peak force ‘W_{M}’ is the area under the force deformation curve bounded by the origin, the peak force and the deformation at peak force. The force exerted by the striker in the direction of impact and measured at failure point is known as failure force ‘F_{F}’. The deformation in the direction of impact at the center of the test specimen, measured at failure point, is known as failure deformation ‘S_{F}’. Failure energy ‘W_{F}’ is the area under the force deformation curve bounded by the origin, the failure force, and the failure deformation. Total penetration energy ‘W_{T}’ is the total energy expended in penetrating the test specimen. The normalized values are for unit thickness of the film. The force deformation diagrams of h-LLDPE and LDPE used in the present study shows a clear point of first failure (failure point) indicated by a sharp drop in force. This failure point is of great significance to us as it would represent the total resistance (failure energy) the film would offer before giving away. Thus, the failure energy may be the deciding factor in selecting the optimum DR and BR.

Tear resistance testing was carried out according to the ASTM D 1922 standard on an Elmendorf tear tester. In this test method the average force required to propagate tearing through a specified length of plastic film after the tear has been initiated was determined. The force in grams was measured using a precisely calibrated pendulum device. The sample was mounted in the pneumatic jaws of the tear testing machine. The specimen is held on one side by the pendulum and on the other side by a stationary member. The cut is initiated using a sharp blade provided in the machine. When the pendulum is released, acting by gravity, the pendulum swings through an arc, tearing the specimen from a precut slit. Since some energy will be consumed in tearing the film, the pendulum has less energy than if it had fallen freely. The loss in energy by the pendulum is indicated on the digital display. The displayed value is a function of the force required to tear the specimen. Normalized tear resistance of the film was calculated by dividing the tear resistance over the thickness of the film. This method is widely used as an index of the tearing resistance in packaging applications. Tear strength of packaging films was expressed in grams/mm. Ten samples in each direction for the same processing conditions were tested, and its average value was reported.

The processability window of h-LLDPE was evaluated in terms of the broadness of BR and DR range at specific temperatures. The temperature that had the widest window was selected. Considering the effect of degradation in the temperature range of 210° C. to 270° C. with an interval of 20° C., the conclusion is that 230° C. is the optimum temperature having the widest window. After selecting this temperature, the DR was varied from 7 to 86, and according to mechanical testing, 21 was selected as the DR in terms of better impact resistance value. The next step was the selection of BR. Three BR's varying from 1.12 to 1.78 (3 values) were tried, which is limited by the bubble stability. The conclusion was reached that BR 1.6 is a suitable value that gives maximum impact resistance of the film. The above values were set constant for the following studies of blend ratios. In this regard we have studied five different blends with two virgin materials, LDPE and h-LLDPE.

This section briefly describes the selection of temperature without degradation and easy processability. A temperature profile of 120/150/180/200/200/200/200° C. was maintained in the extruder. An extruder screw speed of 12 rpm was used and a constant pressure of 14 to 16 bar was maintained at the extruder die exit. Thus, the melt pump speed was set to a constant feeding rate of 10 rpm at 230° C. to pump the material to the film blowing die. The maximum mass flow rate at these feed rates was around 8 g/min. The die temperature was varied from 210° C. to 270° C., and its effect on the operating window of h-LLDPE and LDPE polymer was determined. The bubble stability window for h-LLDPE and LDPE was evaluated by varying the BR and DR while keeping the mass flow rate and the extruder temperature profile constant. At this extruder temperature profile and the mass flow rate, the BR was limited to a maximum of 1.78. The bubble stability was defined as the region wherein the bubble remained stable for the corresponding values of BR and DR. The various bubble instabilities observed during the process were the draw resonance, helicoidal instability, and bubble rupture. The DR could be varied up to the maximum limit of the instrument (Take off unit), and the BR was varied from a minimum to the maximum limit where the bubble either ruptures or touches the cooling air ring, or when there is some kind of instability induced in the bubble. The axis range of BR and DR was kept constant for all the films produced at different temperatures. The BR axis was set to a range of 0 to 3 and the DR was set to a range of 0 to 90. These ranges were selected as it would include all the data points generated for the different materials and the temperatures studied. This way the total area of the plot was maintained constant, and then the operating window area was evaluated and its percentage value was calculated over the total area to give the relative percentage of operating window. This relative percentage area of the operating window was then compared to select the optimum die temperature that gave the maximum bubble stability window without any degradation effect at that temperature. The operating windows of h-LLDPE and LDPE are evaluated at different temperatures. Films produced at these temperatures were tested on the DSC to determine the effect of degradation at these elevated temperatures.

From DSC plots, it is concluded that there is not much degradation. If there is an appreciable degradation, it will be visible. If there is degradation, it will show in the thermal behavior from the DSC profile as a shift in the curve, change of shape (broader or narrower), or change in crystalline content. For example, molecular weight degradation results in smaller or larger molecular weight. Material crystallizing at lower temperature results in smaller molecular weight. If the material crystallizes at higher temperature, it implies that the molecules are less mobile, and therefore larger molecules exist, indicating that crosslinking has occurred. The experimental DSC results show that there is not much deviation in the thermal history of the films when compared to the virgin history of the polymer.

Tensile tests were carried out in accordance with ASTM D882 standard in both MD and TD directions. Five samples were tested in both the directions for each processing condition. Stress-strain of h-LLDPE films at different DRs in machine direction (MD) were plotted. The tensile properties of h-LLDPE at different DRs in MD are listed in Table 1.

TABLE 1
Machine Direction Tensile Properties of h-LLDPE at different DRs

| | UTS | | σ_{y} | | ε_{F} | | T_{E} | |
|---|---|---|---|---|---|---|---|---|
| DR set | (MPa) | STD | (MPa) | STD | (%) | STD | (MPa) | STD |
| 7 | 41.5 | 3.4 | 8.2 | 0.6 | 1231 | 33 | 230 | 25 |
| 21 | 39.7 | 7.9 | 7.1 | 1.8 | 773 | 36 | 129 | 33 |
| 36 | 42.0 | 8.4 | 8.1 | 1.2 | 617 | 54 | 115 | 25 |
| 49 | 27.7 | 3.6 | 4.7 | 0.5 | 493 | 49 | 62 | 11 |
| 64 | 64.5 | 15.1 | 12.9 | 1.8 | 385 | 44 | 127 | 28 |
| 86 | 44.8 | 6.9 | 10.1 | 1.3 | 293 | 43 | 76 | 16 |

The stress strain plots of h-LLDPE films at different DRs in the transverse direction (TD) were also plotted. The tensile properties of h-LLDPE at different DRs in TD are listed in Table 2.

TABLE 2
Transverse Direction tensile properties of h-LLDPE at different DRs

| | Ultimate | | Tensile | | Tensile Strain | | Toughness- | |
|---|---|---|---|---|---|---|---|---|
| | Tensile | | Stress at | | at Break- | | Energy at | |
| | Stress | Std | Yield | Std | Ductility | Std | Break | Std |
| DR set | (MPa) | Dev | (MPa) | Dev | (%) | Dev | (MPa) | Dev |
| 7 | 44.3 | 3.7 | 10.3 | 1.0 | 1294 | 66 | 260 | 0 |
| 21 | 43.4 | 2.8 | 10.0 | 1.0 | 1179 | 41 | 228 | 15 |
| 36 | 23.9 | 5.8 | 6.3 | 1.4 | 993 | 94 | 111 | 31 |
| 49 | 24.8 | 3.0 | 10.0 | 0.9 | 917 | 91 | 64 | 11 |
| 64 | 24.1 | 7.8 | 9.6 | 1.3 | 1004 | 142 | 127 | 37 |
| 86 | 23.2 | 3.7 | 11.3 | 1.6 | 951 | 104 | 125 | 28 |

Impact tests were carried out in accordance with the ISO 7765-2 standard. Five samples were tested at each processing condition (DR), and an average impact energy value has been reported. The force-deformation was computed for five samples tested at all DRs for h-LLDPE films.

The results of thermal and mechanical tests conducted on the h-LLDPE/LDPE films processed at different blend ratios were tested. A die temperature of 230° C., a blow ratio (BR) of around 1.6, and a draw ratio (DR) of 21 were kept constant while the blend ratios were varied.

The first heating cycles of virgin h-LLDPE and LDPE samples were computed. The samples processed at different blend ratios were analyzed and their 1^{st} heating calculated. The melting range of h-LLDPE is observed to be in the range of 115° C. to 124° C.

Tensile tests were carried out in accordance with ASTM D882 standard in both MD and TD directions. Five samples were tested in both the directions for each processing condition. The 15% LDPE blend ratio gives the maximum tensile strength, elongation and toughness in the MD direction. The tensile properties of h-LLDPE/LDPE films at different blend ratios in MD and TD are listed in Tables 3 and 4, respectively. The 15% LDPE blend ratio is the best performing blend, based on strength, elongation and toughness in MD direction, while the 10% LDPE blend ratio is the best performing blend, based on strength, elongation and toughness in TD direction.

TABLE 3
Machine Direction tensile properties of h-LLDPE/LDPE blends

| LDPE | | | | | | | | |
|---|---|---|---|---|---|---|---|---|
| Content | | | | | | | | |
| (%) | UTS | | σ_{y} | | ε_{F} | | T_{E} | |
| set | (MPa) | STD | (MPa) | STD | (%) | STD | (MPa) | STD |
| 0 | 43.6 | 7.2 | 8.2 | 0.9 | 760 | 25 | 137 | 19 |
| 5 | 43.6 | 4.1 | 8.8 | 1.0 | 776 | 13 | 159 | 15 |
| 10 | 42.2 | 8.0 | 9.2 | 1.8 | 768 | 39 | 170 | 40 |
| 15 | 43.9 | 10.8 | 9.6 | 2.1 | 784 | 51 | 195 | 58 |
| 20 | 39.3 | 4.4 | 9.8 | 1.2 | 736 | 26 | 184 | 21 |
| 50 | 27.6 | 1.7 | 7.1 | 0.9 | 223 | 24 | 51 | 6 |
| 100 | 28.8 | 2.8 | 7.2 | 1.1 | 163 | 18 | 33 | 7 |

TABLE 4
Transverse Direction tensile properties of h-LLDPE/LDPE blends

| LDPE | | | | | | | | |
|---|---|---|---|---|---|---|---|---|
| Content | | | | | | | | |
| (%) | UTS | | σ_{y} | | ε_{F} | | T_{E} | |
| set | (MPa) | STD | (MPa) | STD | (%) | STD | (MPa) | STD |
| 0 | 38.7 | 5.4 | 8.4 | 1.1 | 1085 | 37 | 174 | 27 |
| 5 | 25.6 | 9.9 | 8.7 | 1.1 | 1105 | 66 | 172 | 25 |
| 10 | 37.1 | 2.9 | 10.2 | 1.0 | 1177 | 48 | 204 | 20 |
| 15 | 29.1 | 2.3 | 8.4 | 1.4 | 1100 | 59 | 153 | 14 |
| 20 | 26.3 | 5.0 | 7.0 | 1.8 | 1091 | 121 | 137 | 33 |
| 50 | 26.0 | 1.7 | 8.1 | 1.5 | 1039 | 108 | 137 | 28 |
| 100 | 11.9 | 0.9 | 5.9 | 0.6 | 699 | 51 | 54 | 8 |

Impact tests were carried out in accordance with the ISO 7765-2 standard. Five samples were tested at each processing condition and an average impact energy value has been reported. The force-deformation diagrams for pure h-LLDPE, blends with (5%, 10%, 15%, 20% and 50% and 100% LDPE) were obtained. The normalized peak force, peak energy, and total failure energy values for the five films tested at different blend ratios have been listed in Table 5. The 5% LDPE blend ratio is the best blend, based on both impact peak force and toughness, whereas the 50% LDPE blend ratio has the strongest impact failure force.

TABLE 5
Impact test results for different blend ratios

| Blend ratio h- | F_{PN} | | | | E_{TFN} | |
|---|---|---|---|---|---|---|
| LLDPE/LDPE | (N) | STD | E_{PN} (J) | STD | (J) | STD |
| 100-0 | 713 | 50 | 7.1 | 0.7 | 16 | 1.4 |
| 95-5 | 881 | 14 | 7.9 | 0.55 | 18 | 1.2 |
| 90-10 | 800 | 35 | 5.7 | 0.66 | 12 | 1.5 |
| 85-15 | 812 | 27 | 5.5 | 0.34 | 11 | 0.3 |
| 80-20 | 623 | 20 | 4.1 | 0.38 | 7 | 0.6 |
| 50-50 | 629 | 19 | 3.4 | 0.54 | 11 | 1.1 |
| 0-100 | 616 | 40 | 2.9 | 1.5 | 14 | 1.2 |

The tear resistance tests were carried out in accordance with ASTM D1922 standard. Ten samples in both directions and at each processing condition were tested, and an average tear resistance value has been reported. The normalized tear resistance in the MD and the TD directions for h-LLDPE/LDPE blends are listed in Tables 6 and 7. Among the blends, the 5% LDPE blend has the best blend properties based on the tear properties in the MD direction, whereas the 10% LDPE blend has optimum tear properties in the TD direction.

TABLE 6
MD tear properties of h-LLDPE/LDPE blends

| Blend | | | TR_{N} | STD |
|---|---|---|---|---|
| Ratio % | TR g | STD g | kN/m | kN/m |
| 100-0 | 324 | 129 | 105 | 42.0 |
| 95-5 | 220 | 17 | 73 | 5.7 |
| 90-10 | 128 | 22 | 37 | 6.4 |
| 85-15 | 62 | 13 | 23 | 5.0 |
| 80-20 | 51 | 24 | 18 | 8.4 |
| 50-50 | 136 | 22 | 40 | 6.5 |
| 0-100 | 410 | 90 | 118 | 26 |

TABLE 7
TD tear properties of h-LLDPE/LDPE blends

| Blend | | | TR_{N} | STD |
|---|---|---|---|---|
| Ratio % | TR g | STD g | kN/m | kN/m |
| 100-0 | 614 | 78 | 193 | 24.5 |
| 95-5 | 980 | 177 | 329 | 59.5 |
| 90-10 | 1162 | 166 | 382 | 54.7 |
| 85-15 | 1142 | 124 | 384 | 39.9 |
| 80-20 | 1095 | 77 | 390 | 27.5 |
| 50-50 | 539 | 46 | 136 | 11.6 |
| 0-100 | 137 | 11 | 40 | 3.1 |

The entries in Tables 3 and 4 show that TD tensile strength of h-LLDPE/LDPE blends decreases with increase in LDPE content. However some synergistic effects are seen at very low percentage of blends. The MD yield strength of the film blends of h-LLDPE with LDPE increases with the addition of LDPE up to the blends with 10% to 20% LDPE and then later decreases. There is around 20% enhancement in the yield strength of the film in MD for the low ratio blends in MD direction. There is not much loss of ductility in MD direction for the low blend ratios. Ductility of h-LLDPE is four times higher than that of LDPE. The addition of LDPE up to 80-20% blend ratio did not have any decrement in the ductility. This is of great importance as the processability is improved with the addition of LDPE (in terms of reduction in torque) and without losing its tensile properties.

The MD percentage ductility (elongation at break) almost remains constant up to 15% LDPE and then decreases non-linearly with increase in LDPE content. There is not much change in the ductility up to addition of 20% LDPE content. The percentage ductility is higher at higher percentages of h-LLDPE, since h-LLDPE with relatively linear molecules has much more unfailing entanglements during elongation process. The tests for 80-20% and 50-50% blend ratio were repeated with emery paper padding, and the results obtained were observed to be the same. The area of clamping also remained constant before and after the test, indicating that there was no slipping during the tests. The MD toughness for pure h-LLDPE is 140 MPa, and for pure LDPE it is around 30 MPa. With small addition of LDPE content up to 80-20% of blend ratio, the toughness increased to a value of 200 MPa. Thus, there is approximately 43% increment in MD toughness with the addition of LDPE in small quantity.

The profile of stress strain plots of h-LLDPE-LDPE films at different Blend ratios in TD are shown in FIG. 3. The TD tensile strength increased with addition of LDPE in 90-10% of blend ratio. In the TD direction, the ductility of the blend increased by 30% when compared to pure h-LLDPE, just by a small addition of LDPE. The ductility is not reduced by the addition of LDPE content. As also shown in the orientation, this might be due to the alignment of molecules during the tension process. With a blend ratio up to 10%, the toughness in the TD direction has shown a small increase in its properties.

The impact failure energy for different blend ratios is shown in FIG. 2. There was around 20% improvement in impact peak force with the addition of LDPE to h-LLDPE. There is some 20% enhancement in impact failure energy due to 5% blend, followed by a decrease of about 50% for higher blend ratios. The maximum normalized failure energy was observed at a 5% blend ratio. The tear resistance also shows some kind of deterioration in the MD direction, but there is a huge improvement for tear resistance in TD direction. It is that the structure in tensile is quite sensitive to the strain rate. The tear is sudden, and the other molecules in the film that were not aligned did not offer any resistance, nor were getting pulled. The tensile strain rate is slow, and the other molecules that were not aligned start to align themselves when pulled, and thus offer more resistance. However, in TD tear resistance, most of the structure is oriented perpendicular to the MD, and the unaligned molecules hold to give a higher TD tear resistance.

The MD Elmendorf tear resistance was observed to decrease with increase in blend ratio up to 80-20% blend and then increased with further increase in blend ratio. It is observed that as the orientation when viewed from the MD direction increases, the tear resistance in MD direction decreases. The worst tear resistance in MD direction was observed at 20% LDPE content. The TD Elmendorf tear resistance was observed to increase with increase in blend ratio up to a blend ratio of 80-20% (LLDPE-LDPE) blend, and then decreased with further increase in blend ratio, as shown in FIG. 1. This observation is of great importance, as the TD tear resistance increases with an increase in the LDPE blend percentage. There is a difference between MD and TD tear resistance of the two materials. It is observed that the TD tear resistance for pure h-LLDPE is almost twice that of MD tear resistance. On the contrary, LDPE has a reverse trend where the TD tear resistance is almost three times lower when compared to MD tear resistance. There are two different structure development processes for the individual materials, and this opposition shows in the structure development of the blends. In both cases, it has deviated from the linearity rule. It shows that the TD direction tear resistance has improved with an increase in blend ratio. It almost doubled from 200 kN/m to 400 kN/in, whereas in the MD direction the tear resistance has been reduced to relatively low values. According to the tear resistance properties, the blend has modified the structure-morphology of the material, as observed from the tear results. It has improved the TD direction properties, while also deteriorating the MD direction properties.

It has played a big role in modifying the structure development and orientation in the material, which has to be supported by the morphological study. The pure LDPE film has lower TD tear resistance when compared to pure h-LLDPE. There are two competing factors here. First, the blends of the polymer and their properties are to be incorporated. Second, to be considered is the molecular orientation during the process, which can be due to the alignment of the molecules. This can be observed on the low blend percentages of h-LLDPE/LDPE. This low blend molecular characteristic has been demonstrated for MD direction blends up to 20%. It has been noted that the increase in blend percentage leads to increase in orientation, whereas, in this case, the MD tear resistance decreased lower than LLDPE, and which can be attributed to the material properties being significantly incorporated. Therefore, it observed that the TD tear resistance improved by almost 100% by addition of LDPE for the low blend percentages up to 80-20% blend ratio. Prior art studies have associated the difference in tear resistance of the two individual materials with the crystalline lamellar structure formed in the film blowing process. The relationship between structure and tear anisotropy in the LDPE film was attributed to the twisted lamellae from the adjacent row nuclei being strongly connected, resulting in an interlocking lamellae structure. For LLDPE films, a relatively balanced tear resistance was observed from their study, due to the involvement of less oriented structure. The local preferential orientation of lamellae along TD tear resistance was greater than MD tear resistance for LLDPE.

In general, the processability of the process was increased with the addition of LDPE to the h-LLDPE, as the torque required to turn the screw decreased with an increase in the LDPE blend percentage. The processability of the processes was measured in terms of the torque required to turn the extruder screw. Thus, in this manner, the mechanical properties of h-LLDPE are further enhanced by addition of small percentages of LDPE with a lower torque requirement. This implies that the h-LLDPE-LDPE blend produces a film of better mechanical properties with a lower production cost. With addition of up to 20% LDPE blend, many mechanical properties improved. There is no fixed blend percentage where all the mechanical properties increase simultaneously. For blend ratios in the range of 5%-20% of LDPE, it was observed that the optimum mechanical properties, such as tensile, tear and impact strength properties of the film, increased. An individual specimen increases in performance at 15% LDPE in MD tensile strength. Optimum TD tensile strength was observed for 10% LDPE as shown in Table 4. An optimum impact test result was obtained by addition of 5% LDPE. An optimum MD tear property was obtained by addition of 5% LDPE. An optimum TD tear resistance was obtained by addition of 5% LDPE. It has been reported that the energy consumption for extrusion of LLDPE is much higher than that of LDPE, and this has been correlated to the presence of long chain branches. In conclusion, the material with long chain branches has lower energy consumption when compared to the one without it, and a relationship has been established for the energy requirement for blends of these two materials.

The process parameters, such as the melt flow rate, die temperature, DR, and BR were fixed to their optimum values of 80 g/min, 230° C., 21, and 1.6 respectively. Pure h-LLDPE, LDPE, and their blends (5%, 10%, 15%, 20% and 50%) were processed at the above constant processing conditions, and the effect of blending was studied on the thermal and mechanical properties of the films. The crystallinity for different blends was determined using DSC. In general, there was not much change in the crystallinity percentage up to 50% of the blends, and later decreased for LDPE material. The birefringence of the blends has been studied using an optical microscope and an index of orientation has been reported. There is an increase from −3×10⁻³ to 5×10⁻³ when the blend ratio increases from 0 to 50%, and then the birefringence decreases to 3×10⁻³ for the pure LDPE. Mechanical tests, such as tensile, impact and Elmendorf tear test were also conducted on the blended films processed at constant die temperatures, DRs and BRs. The tensile and tear tests were conducted in both MD (machine) and TD (transverse) directions for the blended films. With addition of up to 20% LDPE blend, many mechanical properties improved. There was a 20% enhancement in MD yield strength by small addition of LDPE without any decrement in the MD ductility. The MD toughness also observed an increment of around 43% in its properties with this small addition of LDPE, thus indicating that small amount of LDPE content could enhance the toughness in MD. The TD ductility improved slightly in comparison to pure h-LLDPE.

With blend ratio up to 10%, the toughness in the TD direction has shown small increase in the properties. There is some 20% enhancement in impact failure energy due to 5% blend followed by a decrease of about 40% for higher blend ratios. The tear resistance also shows some kind of decrease in MD direction, but there is a huge improvement for tear resistance in the TD direction. The TD tear resistance improved by almost 100% by addition of LDPE for the low blend percentages up to 80-20% blend ratio. With addition of up to 20% LDPE blend content, many mechanical properties improved. This is of great importance as the processability was improved with the addition of LDPE. As the processability increases there is a reduction (around 15%) in the torque required to process the material. With this decrement in torque requirement, the power consumption would also decrease. Thus, by blending with small percentages of LDPE, the productivity increases without any deterioration in the quality. Rather, it helps in improving the quality in many cases. The normalized peak force values during impact tests were also observed to be higher when compared to the pure h-LLDPE and LDPE. The normalized MD tear resistance was observed to decrease at low blend percentages, whereas it increased for normalized TD tear resistance.

It is to be understood that the present invention is not limited to the embodiments described above, but encompasses any and all embodiments within the scope of the following claims.

1. An LLDPE-LDPE blown film blend, comprising:
between 2% and 10% LDPE (low-density polyethylene); and
between 98% and 90% LLDPE (linear low-density polyethylene), wherein the LLDPE-LDPE blown film blend has a blow up ratio of approximately 1.6.

2. The LLDPE-LDPE blown film blend according to claim 1, wherein said LLDPE is a copolymer with an alpha-olefin, the copolymer being formed using a Ziegler-Natta catalyst.

3. The LLDPE-LDPE blown film blend according to claim 2, wherein said Ziegler-Natta catalyst is a non-metallocene catalyst.

4. The LLDPE-LDPE blown film blend according to claim 2, wherein said LLDPE is unimodal LLDPE.

5. The LLDPE-LDPE blown film blend according to claim 4, wherein said LLDPE has a melt index of about 0.8_g/10 min.

6. The LLDPE-LDPE blown film blend according to claim 5, wherein said LLDPE has a density of about 0.921 g/cm³.

7. The LLDPE-LDPE blown film blend according to claim 6, wherein said alpha-olefin is a hexene monomer.

8. An h-LLDPE-LDPE blown film, comprising a blown film having between 2% and 10% LDPE (low-density polyethylene) blended with between 98% and 90% h-LLDPE (hexene-linear low-density polyethylene), said h-LLDPE having a density of approximately 0.921 g/cm³, and a melt index of approximately 0.8_g/10 min, the film having an ultimate tensile strength of between approximately 37.06 MPa and less than 38.67 MPa in a transverse direction (TD)), wherein the LLDPE-LDPE blown film blend has a blow up ratio of approximately 1.6.

9. The h-LLDPE-LDPE blown film according to claim 8, wherein said h-LLDPE-LDPE blown film has a tear resistance increasing at a constant linear rate between 2% LDPE and about 10% LDPE in the blend.

10. The h-LLDPE-LDPE blown film according to claim 8, wherein said h-LLDPE-LDPE blown film has a failure energy peaking between 2% LDPE and about 6% LDPE in the blend.

11. The h-LLDPE-LDPE blown film according to claim 8, wherein said h-LLDPE-LDPE blown film has an MD toughness peaking at a constant linear rate between 2% LDPE and about 10% LDPE in the blend.
